(19) United States
(12) Patent Application Publication
(10) Pub. No.: US 2007/0000227 A1
(43) Pub. Date: Jan. 4, 2007

(54) Variable configuration rake

(76) Inventors: Ruth Mazar, Ogdensburg, NY (US); Emerick Mazar, Ogdensburg, NY (US)

Correspondence Address: SIMON, GALASSO & FRANTZ PLC., P.O. Box 26503, Austin, TX, 78755-0503, US

(21) Appl. No.: 10/952,671

(22) Filed: Sep. 29, 2004

Related U.S. Application Data
(60) Provisional application No. 60/507,027, filed on Sep. 29, 2003.

(51) Int. Cl. A01D 7/00

(52) U.S. Cl. 56/400.01

(57) ABSTRACT

A rake comprises a variable-length handle, a rake head, a handle locking mechanism and a strap. The rake head is attached to a first end of the variable-length handle and the strap is attached to a second end of the variable-length handle. The variable-length handle includes a first segment and a second segment movably engaged with the first segment for enabling an overall length of the variable-length handle to be adjustable. The handle locking mechanism is engaged between the first segment and the second segment and is configured for selectively preventing relative movement between the first segment and the second segment. The rake head is selectively detachable from the variable-length handle.

### CROSS REFERENCE TO RELATED APPLICATIONS

This application claims priority to co-pending U.S. Provisional Patent Application having Ser. No. 60/507,027, filed Sep. 29, 2003, entitled “Anchor Rake”, having a common applicant herewith.

### FIELD OF THE DISCLOSURE

The disclosures made herein relate generally to hand tools and, more particularly, to rakes.

### BACKGROUND

Various types of hand tools for various tasks are known and widely used. Of particular interest herein are rakes. Conventional rakes have handles of a specified fixed length. The handle length of such conventional rakes is typically specified according to an intended utility. For example, a garden or leaf rake has a relatively long handle when compared to the relatively short handle of a hand rake used for gardening.

In certain specific applications, the fixed length handle of conventional rakes presents undesirable limitations and drawbacks. For example, a relatively short fixed-length handle is limiting for uses where leverage and/or reach of a relatively long fixed-length handle is advantageous. Similarly, a rake with a relatively long fixed length handle is in some instances cumbersome relative to a relatively short fixed-length handle.

Therefore, a rake that overcomes drawbacks and limitations associated with conventional rakes would be useful and novel.

### SUMMARY OF THE DISCLOSURE

In one embodiment, a rake comprises a telescoping handle and a rake head. The telescoping handle has a first end and a second end. The rake head is attached to a first end of the telescoping handle.

In another embodiment, a rake comprises a variable-length handle and a rake head. The variable-length handle has a first end and a second end. The rake head is attached to a first end of the variable-length handle.

In another embodiment, a rake comprises a handle, a rake head and a looped strap. The handle has a first end and a second end. The rake head is attached to a first end of the handle and the rake head is selectively detachable from the handle. The looped strap is attached to the second end of the handle.

Correspondingly, it is a principal object of the inventive disclosures made herein to provide a rake that overcomes drawbacks and limitations associated with conventional rakes. Specifically, rakes in accordance with the inventive disclosures herein advantageously incorporate a variable length handle, a selectively detachable rake head, and/or other novel and useful aspects. Accordingly, rakes in accordance with the inventive disclosures made herein are useful and/or desirable in a number of conventional applications and specialized applications (e.g., cleaning foreign objects such as weeds from a boat anchor).

Turning now to specific embodiments of the inventive disclosures made herein, in at least one embodiment of the inventive disclosures made herein, a telescoping handle of a rake includes a first segment having a hollow body and a second segment having a portion thereof slidably disposed within the hollow body of the first segment for enabling an overall length of the telescoping handle to be variable.

In at least one embodiment of the inventive disclosures made herein, a variable-length handle of a rake includes a first segment and a second segment movably engaged with the first segment for enabling an overall length of the variable-length handle to be adjustable.

In at least one embodiment of the inventive disclosures made herein, a handle locking mechanism is engaged between a first segment and a second segment of the handle and is configured for selectively preventing relative movement between the first segment and the second segment.

In at least one embodiment of the inventive disclosures made herein, the rake head is selectively detachable from the handle.

In at least one embodiment of the inventive disclosures made herein, a looped strap is attached to the second end of the telescoping handle.

These and other objects and embodiments of the inventive disclosures made herein will become readily apparent upon further review of the following specification and associated drawings.

### BRIEF DESCRIPTION OF THE DRAWINGS

FIG. 1 depicts an embodiment of a variable length rake in accordance with the inventive disclosures made herein, wherein the rake is in a retracted configuration.

FIG. 2 depicts the variable length rake of FIG. 1 in an extended configuration.

FIG. 3 depicts an embodiment of a fixed length rake in accordance with the inventive disclosures made herein.

### DETAILED DESCRIPTION OF THE DRAWINGS

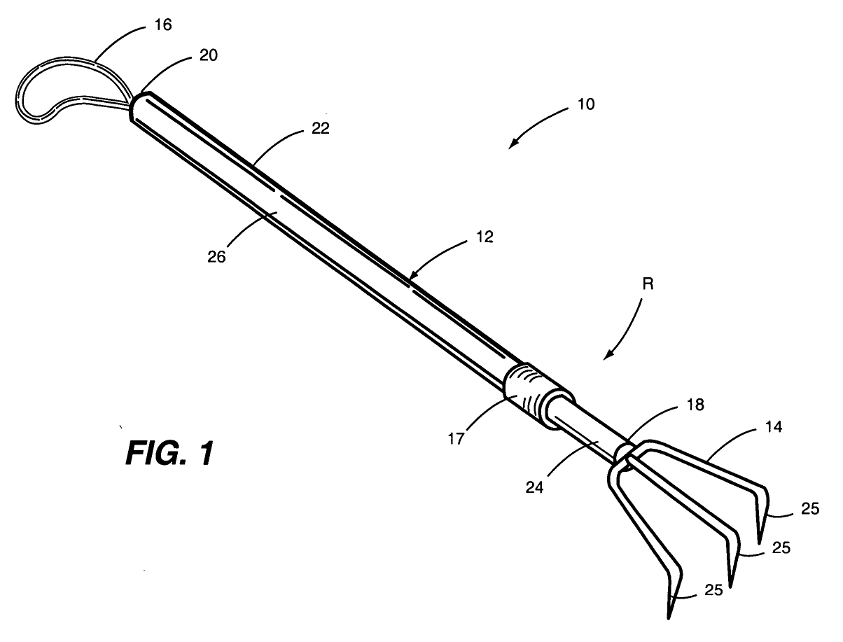

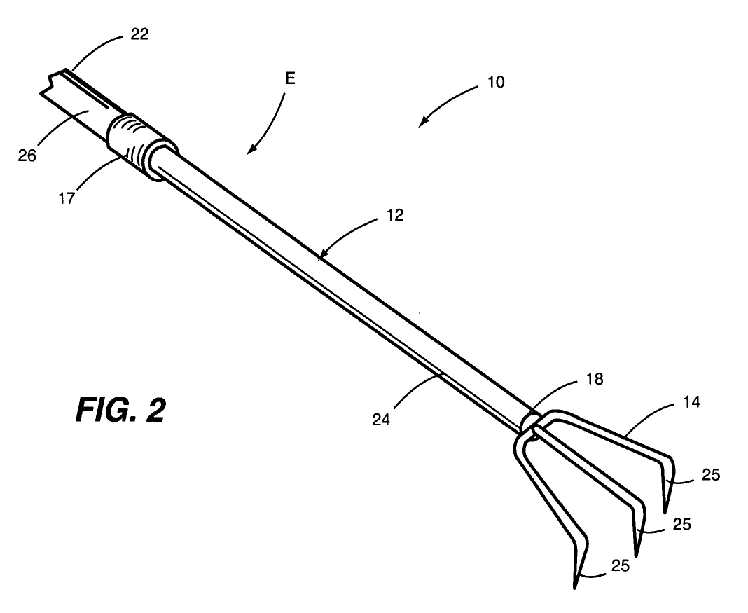

FIGS. 1 and 2 depict an embodiment of a variable length rake 10 in accordance with the inventive disclosures made herein. The variable length rake 10 includes a telescoping handle 12, a rake head 14, a strap 16 (e.g., a looped strap) and a handle locking mechanism 17. The telescoping handle 12 has a first end 18 and a second end 20. The rake head 14 is attached to the first end 18 of the telescoping handle 12 and the strap 16 is attached to the second end 20 of the telescoping handle 12. The strap 16 is provided for securing the rake 12 to the wrist of a user.

The telescoping handle 12 includes a first segment 22 and a second segment 24. The first segment 22 has a hollow body 26 and the second segment has a portion thereof slidably disposed within the hollow body 26 of the first segment 22. In this manner, the first segment 22 and the second segment 24 are configured for enabling an overall length of the telescoping handle to be variable. Variable length capability is advantageous in that it enhances utility and/or applicability of the rake 10.

The second segment 24 is capable of being moved and locked at a variety of positions between a fully retracted position R and a fully extended position E. Preferably, the rake 10 has a length of about 24-36″ when in the fully retracted position R and a length of about 48-72″ when in the fully extended position E. However, rakes in accordance with the inventive disclosures made herein are not limited by particular retracted or extended lengths.

The telescoping handle 12 is an example of a variable length handle. For example, the variable length handle may include a first segment and a second segment that is movably engaged with the first segment for enabling an overall length of the variable-length handle to be adjustable is another suitable embodiment of a handle. Accordingly, handles in accordance with the inventive disclosures made herein need not be telescoping to be variable length.

The handle locking mechanism 17 may be externally disposed (i.e., as depicted in FIGS. 1 and 2) or may be internally disposed (not specifically shown). The handle locking mechanism is engaged between the first segment 22 and the second segment 24 of the telescoping handle 12. Additionally, the handle locking mechanism 17 is configured for selectively preventing relative movement between the first segment and the second segment. Examples of handle locking mechanisms include, but are not limited to, commercially available and/or known collet-type clamp and removable pin arrangements

The rake head 14 include a plurality of tines 25. Preferably, the tines are curved with tapered ends. In one embodiment, the rake head 14 is selectively detachable from the telescoping handle 12. Preferably, the rake head 14 is selectively detachable via a retention feature of the rake head that engages a mating engagement feature of the second segment 24 of the telescoping tube 12. For example, a known and/or commercially-available twist-lock arrangement or threaded engagement arrangement (neither of which is specifically shown) may be implemented for enabling the rake head 14 to be selectively detachable from the telescoping handle 12. Detachability allows for replacement with other types of heads (e.g., a brush head, a hook head, etc) and/or replacement with a different or similar size rake head.

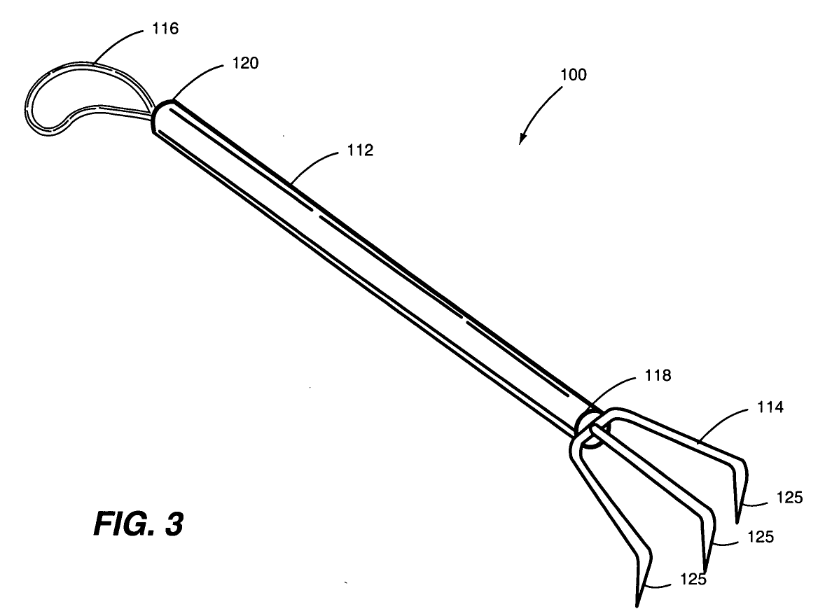

Referring now to FIG. 3, an embodiment of a fixed length rake 100 in accordance with the inventive disclosures made herein is depicted. The fixed length rake 100 includes a handle 112, a rake head 114 and a strap 116. The handle 112 has a first end 118 and a second end 120. The rake head 114 is attached to the first end 118 of the handle 112 and the strap 116 is attached to the second end 120 of the handle 12.

The rake head 114 include a plurality of tines 125. Preferably, the tines are curved with tapered ends. In one embodiment, the rake head 114 is selectively detachable from the telescoping handle 112. Preferably, the rake head 114 is selectively detachable via a retention feature of the rake head that engages a mating engagement feature of the second segment 124 of the telescoping tube 112. Examples of specific means for enabling the rake head 114 to be selectively detachable from the handle 112 are discussed above in reference to FIGS. 1 and 2.

It is disclosed herein that handles of rakes in accordance with the inventive disclosures made herein may be made from any number of materials. Examples of such materials include, but are not limited to, wood, aluminium, laminate composite (e.g., fibreglass) and plastic. Preferably, such handles have a relatively lightweight and corrosion-resistant construction. Similarly, it is preferred that the rake head be made from a corrosion-resistant material such as stainless steel.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice embodiments of the inventive disclosures made herein. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A rake, comprising:
a telescoping handle having a first end and a second end; and
a rake head attached to a first end of the telescoping handle.

2. The rake of claim 1 wherein the telescoping handle includes:
a first segment having a hollow body; and
a second segment having a portion thereof slidably disposed within the hollow body of the first segment for enabling an overall length of the telescoping handle to be variable.

3. The rake of claim 2, further comprising:
a handle locking mechanism engaged between the first segment and the second segment and configured for selectively preventing relative movement between the first segment and the second segment.

4. The rake of claim 3 wherein the rake head is selectively detachable from the telescoping handle.

5. The rake of claim 1, further comprising:
a strap attached to the second end of the telescoping handle.

6. The rake of claim 1 wherein the rake head is selectively detachable from the telescoping handle.

7. The rake of claim 1, further comprising:
a handle locking mechanism; and
a strap attached to the second end of the telescoping handle;
wherein the telescoping handle includes a first segment having a hollow body and a second segment having a portion thereof slidably disposed within the hollow body of the first segment for enabling an overall length of the telescoping handle to be variable;
wherein the handle locking mechanism is engaged between the first segment and the second segment and is configured for selectively preventing relative movement between the first segment and the second segment; and
wherein the rake head is selectively detachable from the telescoping handle.

8. A rake, comprising:
a variable-length handle having a first end and a second end; and
a rake head attached to a first end of the variable-length handle.

9. The rake of claim 8 wherein the variable-length handle includes:
a first segment; and
a second segment movably engaged with the first segment for enabling an overall length of the variable-length handle to be adjustable.

10. The rake of claim 9, further comprising:
a handle locking mechanism engaged between the first segment and the second segment and is configured for selectively preventing relative movement between the first segment and the second segment.

11. The rake of claim 10 wherein the rake head is selectively detachable from the variable-length handle.

12. The rake of claim 8, further comprising:
a strap attached to the second end of the variable-length handle.

13. The rake of claim 8 wherein the rake head is selectively detachable from the variable-length handle.

14. The rake of claim 8, further comprising:
a handle locking mechanism; and
a strap attached to the second end of the variable-length handle;
wherein the variable-length handle includes a first segment and a second segment movably engaged with the first segment for enabling an overall length of the variable-length handle to be adjustable;
wherein the handle locking mechanism is engaged between the first segment and the second segment and is configured for selectively preventing relative movement between the first segment and the second segment; and
wherein the rake head is selectively detachable from the variable-length handle.

15. A rake, comprising:
a handle having a first end and a second end;
a rake head attached to a first end of the handle, wherein the rake head is selectively detachable from the handle; and
a strap attached to the second end of the handle.
